(19) United States
(12) Patent Application Publication
(10) Pub. No.: US 2006/0264197 A1
(43) Pub. Date: Nov. 23, 2006

(54) MOBILE DEVICE BATTERY WARNING FOR DATA DOWNLOADS

(75) Inventors: Hassan Mahini, Carboro, NC (US); Dhaval Parekh, Morrisville, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 10/908,678

(22) Filed: May 23, 2005

(51) Int. Cl. H04B 1/16

(52) U.S. Cl. 455/343.5

(57) ABSTRACT

A method of determining the power required by a mobile device to download a desired file from a remote source. The method estimates the power needed to download the desired file from the remote source. The method then estimates the remaining power currently available to the mobile device. The two estimates are then compared. The mobile device will display a warning when the estimated power required to download a desired file from the remote source is within a predetermined value to the estimated remaining power currently available to the mobile device.

### BACKGROUND

The wireless industry is rapidly developing content driven applications for mobile devices to complement traditional voice applications. Content includes music, still and motion video, etc. The goal is to provide mobile device users with a wide variety of services and features.

Many mobile device users are currently able to download files to their mobile wireless and handheld devices. To accommodate these larger files, the mobile devices now include larger storage capacity. Additional internal storage mechanisms and removable storage devices such as memory sticks or flash memory devices can add a significant amount memory capacity required to handle the larger audio and video files that can be downloaded and executed on a mobile device. A typical MP3 audio file can occupy up to 10 Mb of memory. Video files such as MPEG can take up even more space.

There are also an increased number of content providers that constantly are adding to their offerings. In many cases user can purchase content files and download them to their mobile devices.

The download process, however, takes time and battery resources. In some cases the user can lose content if their mobile device loses too much battery power before the download process is completed. This can be annoying and costly especially if the user has been already billed and the purchased content download is terminated prematurely.

What is needed is a mechanism to help ensure that there is enough battery power remaining to allow a purchased download to complete.

### SUMMARY

The present invention provides a mechanism for a mobile device to estimate the power required to download a desired file from a remote source. The mobile device includes, inter alia, a digital processor, a battery, a battery warning software application executable by the digital processor, and a user interface that can access and manipulate the battery warning software application as well as display data generated by the battery warning software application. The mobile device further provides a communications module coupled with the digital processor for providing a communications link to the remote source such that the desired file to be downloaded can be wirelessly received by the mobile device. In addition, the mobile device also includes a data storage mechanism for storing the desired file to be downloaded from the remote source once it is wirelessly received by the mobile device. However, if the data file to be downloaded is streaming data (audio, video, or both), then the “data file” need not be stored but buffered in memory instead.

The present invention may also be implemented as a battery warning software application resident in a mobile device and executable by the mobile device. The mobile device includes a display and is able to wirelessly exchange data with a remote source. The battery warning software application includes a download estimation component comprised of computer program code that estimates the power required to download a desired file from the remote source. The battery warning software application further includes a remaining battery time estimation component comprised of computer program code that estimates the remaining power currently available to the mobile device. Also included is a comparison component comprised of computer program code that compares the estimated power required to download a desired file from the remote source to the estimated remaining power currently available to the mobile device. In addition, a user interface component is included comprised of computer program code that displays a warning on the mobile device's display when the estimated power required to download a desired file from the remote source is within a predetermined value to the estimated remaining power currently available to the mobile device. The battery warning software application is also linked with a communications component comprised of computer program code that provides a communications link to the remote source such that the desired file to be downloaded from the remote source can be wirelessly received by the mobile device. The battery warning software further allows a data storage component comprised of computer program code to store the desired file to be downloaded from the remote source in a data storage device once it is wirelessly received by the mobile device.

The present invention may also be implemented as a method of estimating the power required by a mobile device to download a desired file from a remote source. The method estimates the power needed to download the desired file from the remote source and the remaining power currently available to the mobile device. The method then compares the power needed to download the desired file from the remote source to the remaining power currently available to the mobile device. If the estimated power required to download a desired file from the remote source is within a predetermined value to the estimated remaining power currently available to the mobile device, then the mobile device displays a “Low Battery” warning.

### BRIEF DESCRIPTION OF THE DRAWINGS

FIG. 1 is a block diagram illustrating functions and components that comprise the present invention.

FIG. 2 is a textual sub-menu illustrating a sample list of selectable content files that can be downloaded.

FIG. 3 is a view of a “Low Battery” warning screen used to inform the user that the mobile device may not be able to complete the download before the battery gets too weak.

FIG. 4 is a flowchart of logic used to carry out the present invention.

### DETAILED DESCRIPTION

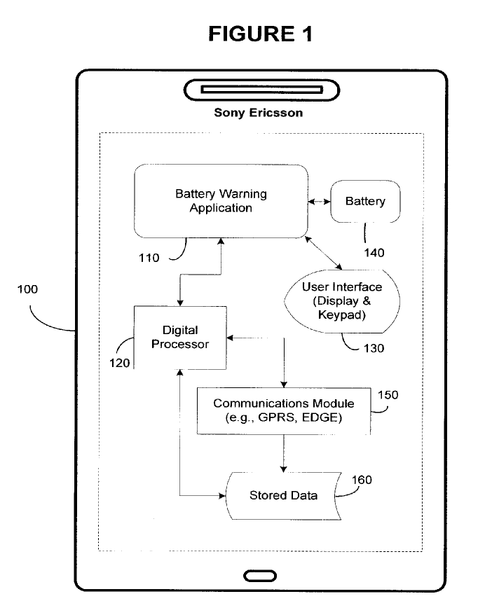

FIG. 1 is a block diagram illustrating functions and components that comprise the present invention. A mobile device 100 includes a battery warning software application 110 that is executable by a digital processor 120. The battery warning software application is also coupled with a user interface 130 and the power source 140 (battery) of the mobile device 100. The digital processor 120 is further coupled with a communications module 150 and a storage mechanism 160. The storage mechanism can be an internal storage device or a removable storage medium such as a memory stick, or both.

The communications module 150 is enabled to wirelessly communicate with a content provider over a data protocol such as General Packet Radio Service (GPRS) or Enhanced Data for Global Evolution (EDGE). Other data protocols can be implemented without affecting the processes of the present invention.

The user responds to the output of the battery warning software application 110 via the user interface 130. The user interface is primarily comprised of the mobile device's display and keypad. Audible alerts can also be part of the user interface.

When a user successfully downloads a content data file via the communications module 150, it will be stored within the mobile device or on a removable storage media. This is illustrated as stored data 160 in FIG. 1.

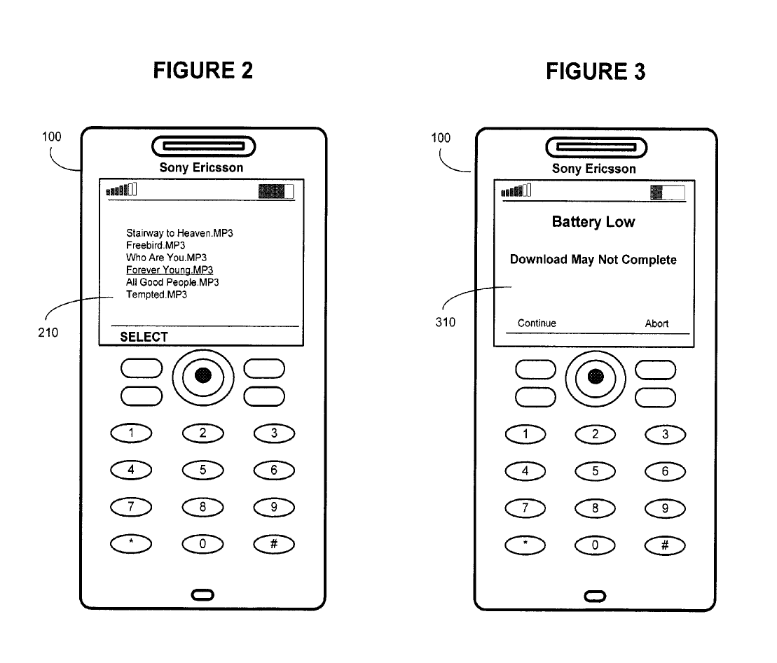

FIG. 2 is a textual sub-menu illustrating a sample list of selectable content files that can be downloaded to the user's mobile device 100. The present invention is described without getting into the particulars of how a content file is purchased and downloaded from a content provider. The present invention is focused on ensuring that the download process will not fail for lack of battery power regardless of the actual download process. Thus, FIG. 2 presents a generic menu listing 210 of selections of audio data files. This example assumes that the mobile user has accessed a content provider's mobile service and has been pushed a list 210 of eligible audio files for download. This list 210 could have been the product of a search query. In this example, the selection “Forever Young.MP3” has been underlined indicating that the user wishes to select and download this file. It is presumed that the user has a subscription with the content provider and will be billed upon initiation of the download.

FIG. 3 is a view of a “Low Battery” warning screen 310 used to inform the user that the mobile device 100 may not be able to complete the download before the battery gets too weak. This screen will be displayed when the mobile device determines that the battery power that is likely needed to accomplish the download could exceed the remaining battery life of the mobile device in its current state. The user then has the option of aborting the download prior to incurring a download fee. Or, if the user happens to be near a power charging source, he can connect the mobile device to the power charging source before continuing with the download.

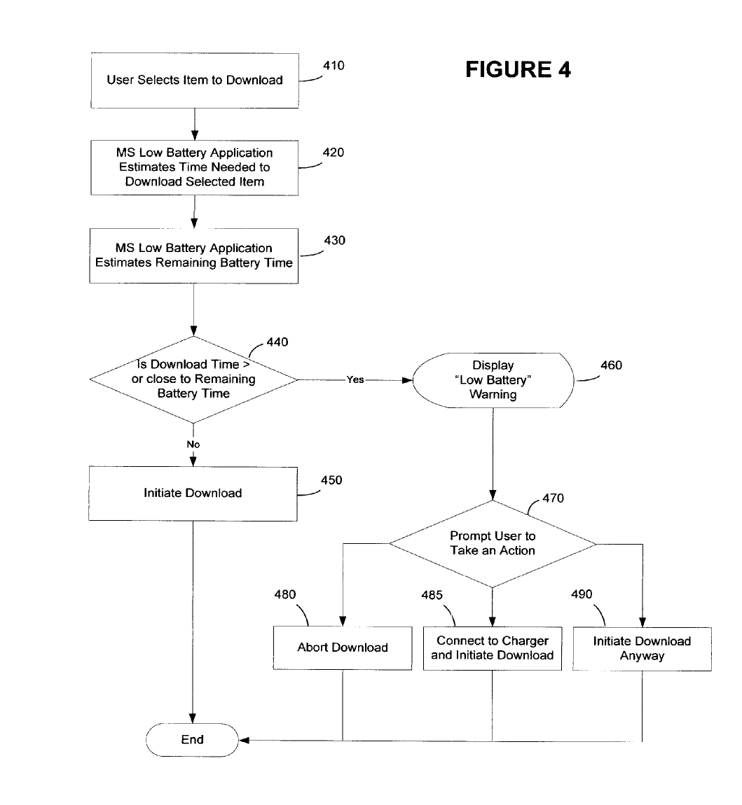

FIG. 4 is a flowchart of logic used to carry out the present invention. The first step shown in FIG. 4 calls for the user to select an item to download 410. This presupposes that the user's mobile device is capable of performing such a task and that the user has already manipulated the mobile device to present a list similar to the one shown in FIG. 2. The actual format and presentation of such a list is not patentably relevant to the present invention as it is merely illustrative in nature. Moreover, the type of file to be downloaded and any fee arrangement for such a download are also considered to be tangential to the present invention. The present invention provides a mechanism to determine whether the mobile device's battery contains ample reserves to perform the desired task.

Once the user has selected a file to download, the mobile device estimates the time (and power) needed to download the selected item 420. This calculation is an estimation based on several factors including, but not limited to, the size of the file to be downloaded, the current effective bandwidth of the wireless data connection between the mobile device and the host server containing the file to be downloaded, and the current signal quality of the wireless data connection. File size data is typically supplied by the content provider with an item when originally listed. This is a courtesy to the user so that the user can determine if their device has the required memory to receive and store the desired file. The other parameters can be determined by the mobile device itself while monitoring the communications channel it is currently using.

The mobile device then estimates the time (and power) currently remaining on the mobile device 430. The MS low battery application running on the mobile device then compares the time/power required to complete the download against the time/power remaining on the mobile device 440. If the time/power remaining on the mobile device 430 exceeds the estimate for the time/power required to complete the download 420, then the mobile device will initiate the download 450 without further delay. However, if the time/power remaining on the mobile device 430 is less than the estimate for the time/power required to complete the download 420, then the mobile device will display a “Low Battery” warning 460 similar to the one shown in FIG. 3.

The MS low battery application can set tolerances or thresholds for the comparison. For instance, the MS low battery application may require that the time/power required to complete the download 420 exceed the time/power remaining on the mobile device 430 by a threshold amount before initiating a download. Such tolerances or thresholds can have a default setting but can be overwritten or changed by the user if desired.

In addition to displaying a “Low Battery” warning 460, the mobile device will also prompt the user to select a course of action 470. There are three courses of action shown in FIG. 4 including: aborting the download 480, connecting the mobile device to a power charger (if readily available) 485 before continuing with the download, or initiating the download despite the “Low Battery” warning 490.

The foregoing description has focused on a mobile phone or mobile device and its power consumption when faced with a download scenario. The principles can be readily applied to a portable computer (PC) such as a laptop since a laptop is often operated in a battery powered mode. As such, a mobile device is intended to include a mobile phone, a laptop or notebook computer, a personal digital assistant (PDA), and any other device exhibiting portable mobility that relies on battery power to operate in certain situations.

Laptops can use a wide variety of data connections to host servers on remote networks. The laptop can connect to a network node via a direct wire connection such as Ethernet, a wireless LAN connection such as WiFi or Bluetooth™, or a mobile wireless connection such as a PCM card running a wireless protocol like those used by mobile devices.

There are also many instances in which a laptop can be used to download data files for a fee. One particularly common example is a music download via an Internet service such as I-Tunes™.

In addition, the description (and subsequent claims) have been characterized in terms of a data file that is to be downloaded. Data file can include, but is not limited to, audio files, video files, text files, streaming audio data, streaming video data, or a combination audio/video streaming data.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

What is claimed is:

1. A mobile device that can estimate the power required to download a desired file from a remote source, the mobile device comprising:
a digital processor;
a battery;
a battery warning software application executable by the digital processor; and
a user interface for accessing and manipulating the battery warning software application and displaying data generated by the battery warning software application.

2. The mobile device of claim 1 further comprising a communications module coupled with the digital processor, the communications module for providing a communications link to the remote source such that the desired file to be downloaded from the remote source can be wirelessly received by the mobile device.

3. The mobile device of claim 2 further comprising a data storage mechanism for storing the desired file to be downloaded from the remote source once it is wirelessly received by the mobile device.

4. A battery warning software application resident in a mobile device and executable by the mobile device in which the mobile device includes a display and is able to wirelessly exchange data with a remote source, the battery warning software application comprising:
a download estimation component comprised of computer program code that estimates the power required to download a desired file from the remote source;
a remaining battery time estimation component comprised of computer program code that estimates the remaining power currently available to the mobile device;
a comparison component comprised of computer program code that compares the estimated power required to download a desired file from the remote source to the estimated remaining power currently available to the mobile device; and
a user interface component comprised of computer program code that displays a warning on the mobile device's display when the estimated power required to download a desired file from the remote source is within a predetermined value to the estimated remaining power currently available to the mobile device.

5. The battery warning software application of claim 4 further comprising a communications component comprised of computer program code that provides a communications link to the remote source such that the desired file to be downloaded from the remote source can be wirelessly received by the mobile device.

6. The battery warning software application of claim 5 further comprising a data storage component comprised of computer program code that stores the desired file to be downloaded from the remote source in a data storage device once it is wirelessly received by the mobile device.

7. A method of estimating the power required by a mobile device to download a desired file from a remote source, the method comprising:
estimating the power needed to download the desired file from the remote source;
estimating the remaining power currently available to the mobile device;
comparing the power needed to download the desired file from the remote source to the remaining power currently available to the mobile device; and
displaying a warning on the mobile device when the estimated power required to download a desired file from the remote source is within a predetermined value to the estimated remaining power currently available to the mobile device.
